(19) United States
(12) Patent Application Publication
(10) Pub. No.: US 2006/0075384 A1
(43) Pub. Date: Apr. 6, 2006

(54) Method, system and program product for managing application forms

(75) Inventors: Brian G. Farn, Toronto (CA); Vadim Berestetsky, North York (CA); Kou-Mei Chuang Lui, Toronto (CA)

Correspondence Address: HOFFMAN, WARNICK & D'ALESSANDRO LLC, 75 STATE ST, 14 FL, ALBANY, NY, 12207, US

(73) Assignee: International Business Corporation, Armonk, NY (US)

(21) Appl. No.: 10/957,246

(22) Filed: Oct. 1, 2004

(51) Int. Cl. G06F 9/44

(52) U.S. Cl. 717/114

(57) ABSTRACT

An improved solution for managing application forms for an application executing on a client. A form tree that includes one or more application forms is managed on a server. The form tree enables the relationship between the various application forms to be maintained on the server. Rendering information is provided to the application for processing. In particular, the application can display each application form to a user. In response to one or more actions by the user, the application provides requests that include the user interface events to the server, which are processed on the server.

### BACKGROUND OF THE INVENTION

1. Technical Field

The invention relates generally to managing application forms for an application, and more particularly, to a solution for managing multiple application forms on a server for an application executing on a client.

2. Background Art

Various solutions are used for displaying content communicated over a network such as the Internet to a user. One solution is the use of Java Server Faces (JSF) technology. JSF is a server-side web application technology for Java technology-based web applications. In particular, a JSF servlet executing on the web application server receives a request from a web browser application executing on a client, and responds by sending a web page back to the web browser. In generating the web page, the JSF servlet will perform any processing that is required to create the web page subsequently displayed to the user. For example, the JSF servlet will handle any user interface events, perform data validation, data conversion, etc. As a result, the web browser is not required to perform any Java processing or the like to display the web page.

Typically, a web browser does not support the simultaneous display of multiple web pages. To this extent, JSF technology supports the display of only a single web page for a communications session with the web browser. However, many applications executing on a windows-based system can display multiple application forms simultaneously. For example, an application can comprise a main application form and one or more additional forms displayed in a child window, canvas, or other type of dialog. As a result, JSF technology cannot be used to provide server-side application form processing for these applications.

In light of this, a need exists for an improved solution for performing server-side management of application forms such as JSF pages. In particular, a need exists for a method, system and program product that can manage multiple application forms on a server for an application executing on a client.

### SUMMARY OF THE INVENTION

The invention provides a solution for managing application forms. Specifically, under the present invention, one or more application forms for an application executing on a client are managed on a server in communication with the client. In particular, a form tree, which stores the application form(s) and their corresponding relationships, is created and managed on the server. The application can send one or more user interface events to the server, which applies the user interface events to the form tree and sends a corresponding response to the application. The response may include rendering information to enable the application to update the display for the one or more application forms. In one embodiment of the invention, each application form comprises a Java Server Faces (JSF) form (page), and the request information and processing in the various phases of JSF are modified to support multiple JSF forms.

A first aspect of the invention provides a method of managing application forms on a server, the method comprising: generating a form tree for an application executing on a client; generating a first application form for the application; and adding the first application form to the form tree.

A second aspect of the invention provides a method of managing Java Server Faces (JSF) forms on a server, the method comprising: generating a form tree for an application executing on a client; generating a first JSF form for the application; and adding the first JSF form as a root form for the form tree.

A third aspect of the invention provides a system for managing application forms on a server, the system comprising: a form system for generating an application form for an application executing on a client; and a form tree system for generating a form tree for the application and adding the application form to the form tree.

A fourth aspect of the invention provides a program product stored on a recordable medium for managing application forms on a server, which when executed comprises: program code for generating a form tree for an application executing on a client; program code for generating a first application form for the session; and program code for adding the first application form to the form tree.

A fifth aspect of the invention provides a method of deploying an application for managing application forms on a server, the method comprising: providing a computer infrastructure being operable to: generate a form tree for an application executing on a client; generate an application form for the application; add the application form to the form tree; receive a user interface event from the application; and apply the user interface event to the form tree.

A sixth aspect of the invention provides computer software embodied in a propagated signal for managing application forms on a server, the computer software comprising instructions to cause a computer system to perform the following functions: generate a form tree for an application executing on a client; generate an application form for the application; add the application form to the form tree; receive a user interface event from the application; and apply the user interface event to the form tree.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing application forms according to one embodiment of the invention;

FIG. 2 shows an illustrative form tree according to one embodiment of the invention;

FIG. 3 shows illustrative steps for a reconstitute component tree phase of processing a request;

FIG. 4 shows illustrative steps for an apply request values phase of processing a request;

FIG. 5 shows illustrative steps for an invoke application phase of processing a request; and

FIG. 6 shows illustrative steps for a render response phase of processing a request.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing application forms. Specifically, under the present invention, one or more application forms for an application executing on a client are managed on a server in communication with the client. In particular, a form tree, which stores the application form(s) and their corresponding relationships, is created and managed on the server. The application can send one or more user interface events to the server, which applies the user interface events to the form tree and sends a corresponding response to the application. The response may include rendering information to enable the application to update the display for the one or more application forms. In one embodiment of the invention, each application form comprises a Java Server Faces (JSF) form (page), and the request information and processing in the various phases of JSF are modified to support multiple JSF forms.

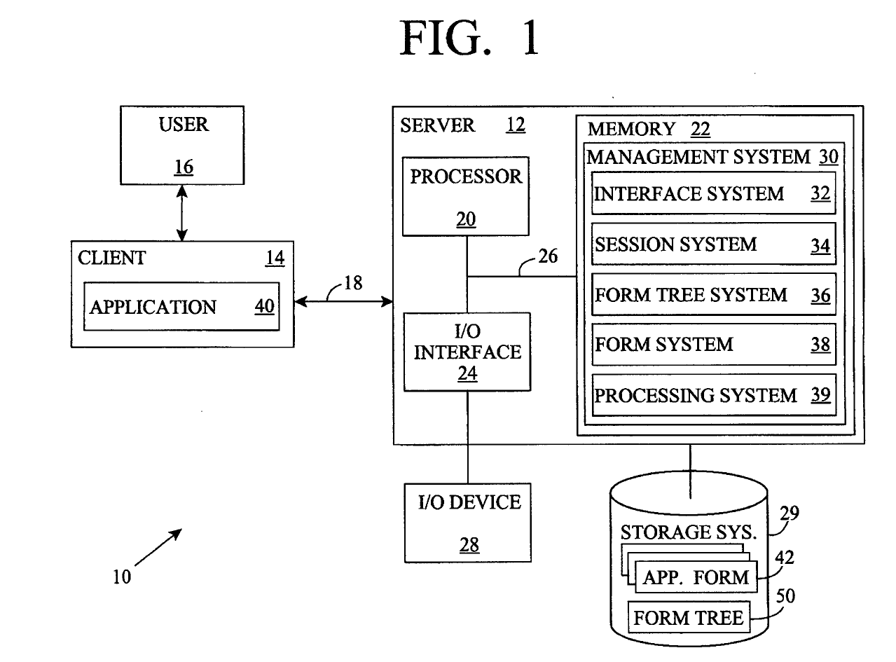

Turning to the drawings, FIG. 1 shows an illustrative system 10 for managing application forms. In particular, a management system 30 on a server 12 manages a set of application forms 42 for an application 40 executing on a client 14 using a form tree 50. A user 16 can generate one or more user interface events by interacting with application 40. In response, application 40 can generate a request for one or more of the user interface events, and forward the request to a management system 30 for processing. Management system 30 applies each request (e.g., user interface event) to form tree 50, and provides a response that can include rendering information for application 40. Subsequently, application 40 can process the rendering information to update the application form(s) 42 displayed to user 16.

In general, communications between management system 30 (server 12), and application 40 (client 14) occur over a network 18. To this extent, network 18 can comprise any combination of various types of communications links. For example, network 18 can comprise addressable connections that may utilize any combination of wireline and/or wireless transmission methods. In this instance, server 12 and client 14 may utilize conventional network connectivity, such as Token Ring, Ethernet, WiFi or other conventional communications standards. Further, network 18 can comprise one or more of any type of network, including the Internet, a wide area network (WAN), a local area network (LAN), a virtual private network (VPN), etc. Where client 14 communicates with server 12 via the Internet, connectivity could be provided by conventional TCP/IP sockets-based protocol, and client 14 could utilize an Internet service provider to establish connectivity to server 12.

In system 10, management system 30 is implemented on server 12 as computer program code. To this extent, server 12 is shown including a processor 20, a memory 22, an input/output (I/O) interface 24, and a bus 26. Further, server 12 is shown in communication with an external I/O device/resource 28 and a storage system 29. In general, processor 20 executes computer program code such as management system 30, that is stored in memory 22 and/or storage system 29. While executing computer program code (e.g., management system 30), processor 20 can read and/or write data (e.g., form tree 50) to/from memory 22, storage system 29, and/or I/O interface 24. Bus 26 provides a communication link between each of the components in server 12. I/O device 28 can comprise a device that enables a user to interact with server 12 (e.g., keyboard, pointing device, display, etc.), and/or a device that enables server 12 to communicate with one or more other computing devices such as client 14 (e.g., network adapter, I/O port, modem, etc.).

Server 12 is only representative of various possible combinations of hardware. For example, processor 20 may comprise a single processing unit, or be distributed across one or more processing units in one or more locations, e.g., on a client and server. Similarly, memory 22 and/or storage system 29 can comprise any combination of various types of data storage and/or transmission media that reside at one or more physical locations. Further, I/O interface 24 can comprise any system for exchanging information with one or more I/O devices 28. Still further, it is understood that one or more additional components (e.g., system software, math co-processor, etc.) not shown in FIG. 1 can be included in server 12.

While the respective computing devices are shown and referred to herein as server 12 and client 14, the terms “server” and “client” are used only for illustration, and do not specify a particular type or configuration of the respective computing devices. To this extent, server 12 can comprise any type of computing device such as a network server, a desktop computer, a laptop, a handheld device, a mobile phone, a pager, a personal data assistant, etc., that is capable of communicating with one or more other computing devices (e.g., client 14). Similarly, client 14 can comprise any type of computing device, and typically includes the same elements as shown in server 12 (e.g., CPU, memory, I/O interface, etc.). These have not been separately shown and discussed for brevity. However, if client 14 and/or server 12 comprises a handheld device or the like, it is understood that one or more I/O devices 28 (e.g., a display) and/or storage system 29 could be contained within client 14 and/or server 12, not externally as shown.

As discussed further below, management system 30 manages a set (one or more) of application forms 42 for application 40 using form tree 50. To this extent, management system 30 is shown including an interface system 32 for communicating with application 40, a session system 34 for managing a session for communicating with application 40, a form tree system 36 for managing form tree 50, which includes one or more application forms 42 for application 40, a form system 38 for generating application forms 42, and a processing system 39 for applying one or more user events to form tree 50. Operation of each of these systems is discussed further below. It is understood that some of the various systems shown in FIG. 1 can be implemented independently, combined, and/or stored in memory for one or more separate servers 12 that communicate over a network. Further, it is understood that some of the systems and/or functionality may not be implemented, or additional systems and/or functionality may be included as part of system 10.

Initially, user 16 may use client 14 to launch application 40. Application 40 can comprise any type of software product that displays information to user 16 and enables user 16 to perform one or more operations on the information. For example, application 40 can comprise any software application that executes using a windows-based operating system (e.g., Mac OS™) as are commonly known in the art. However, it is understood that application 40 is not limited to this particular embodiment. For example, application 40 could comprise embedded software, firmware, or the like.

In any event, application 40 will display an application form 42 in each window that is generated for application 40. Application form 42 can comprise any type of data for displaying information. In one embodiment, application form 42 comprises a document encoded using a standard generalized markup language (SGML) such as hypertext markup language (HTML), extensible markup language (XML), or the like. To this extent, application form 42 can comprise an HTML form that is generated based on a Java Server Faces (JSF) form.

In order to manage application form(s) 42 for application 40, management system 30 generates form tree 50 for application 40. In one embodiment, when application 40 is launched, application 40 can generate and send a request to management system 30 for a first application form 42. Subsequently, interface system 32 can receive the request and session system 34 can create a session for communicating with application 40 in response to the request. Additionally, form tree system 36 can create form tree 50 for the session.

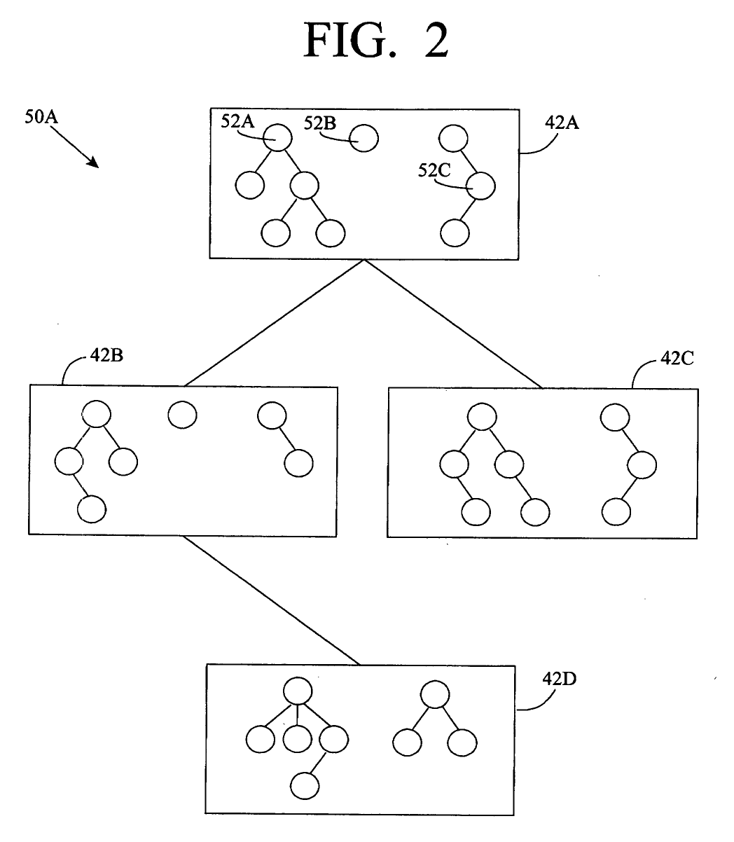

Form tree 50 comprises any hierarchical data structure that can represent a plurality of application forms 42 and their corresponding relationships. To this extent, form tree 50 can be implemented and stored using any known solution such as a directory structure, one or more entries in a database, etc. For example, FIG. 2 shows an illustrative form tree 50A that comprises a plurality of application forms 42A-D and their corresponding relationships. In particular, application form 42A comprises a parent form for application forms 42B-C, and application form 42B comprises a parent form for application form 42D.

Further, each application form 42A-D can include one or more components 52A-C. Each component 52A-C comprises a user interface item that may generate a user interface event and/or be modified by a user interface event. To this extent, components 52A-C can also have a hierarchical relationship. In this case, form system 38 (FIG. 1) can generate a component tree for each application form 42A-D. Similar to form tree 50A, the component tree would include information on each component and their corresponding relationship(s). However, since multiple top-level components may be included in application forms 42A-D, a root node can be included in the component tree, which has each top-level component (e.g., components 52A-B), as a child node.

In any event, returning to FIG. 1, form tree system 36 creates form tree 50 and associates it with the session used in communicating with application 40. Subsequently, form system 38 can generate the requested application form, such as application form 42A (FIG. 2), and form tree system 36 can add application form 42A to form tree 50. For example, when application form 42A comprises the initial application form 42 for application 40, form tree system 36 can make application form 42A a root node of form tree 50. Finally, interface system 32 can provide a response that includes rendering information to client 14 for processing by application 40. In this case, the rendering information can comprise information necessary for initially displaying the application form 42. Further, the identifier for the session can also be included in the response for use in subsequent communications between application 40 and management system 30.

After application 40 displays application form 42 based on the rendering information, user 16 may generate a user interface event by interacting with application 40 and the displayed application form 42. The user interface event comprises any type of event that may alter the display of application form(s) 42 by application 40. For example, the user interface event may comprise a request to open a new application form 42, close an existing application form 42, modify the content of application form 42, or the like. Regardless, application 40 can generate a request based on the user interface event and provide the request to management system 30 for processing.

Interface system 32 can receive the request (e.g., user interface event), and processing system 39 can apply the user interface event to form tree 50A (FIG. 2). To this extent, processing system 39 can determine the application form 42A-D (FIG. 2) and/or component 52A-C (FIG. 2) that generated the user interface event and perform one or more actions specified by the user interface event. To enable this, the request may include information on the source application form 42A-D in form tree 50A and/or a corresponding component 52A-C that generated the user interface event. In this manner, processing system 39 can locate the correct application form 42A-D and/or component 52A-C for processing the user interface event.

For example, the user interface event can comprise one or more property values that have been modified by user 16. In this case, processing system 39 would apply the property value for the user interface event to form tree 50. In particular, the source application form 42A-D (FIG. 2) and/or component 52A-C (FIG. 2) would be located and the new property value would be set. Further, the new property value may impact one or more components 52A-C on one or more additional application forms 42A-D. As a result, processing system 39 can apply the property value to each application form 42A-D and/or component 52A-C that is impacted.

Additionally, the request can comprise control logic that is generated based on the user interface event. The control logic can include, for example, a close operation to be performed on one or more application forms 42A-D (FIG. 2). In this case, processing system 39 can remove the corresponding application form 42A-D and its descendent application form(s) 42A-D (e.g., application forms 42B-D for application form 42A or application form 42D for application form 42B) from form tree 50A (FIG. 2) and provide rendering information for processing by application 40 that indicates the application form(s) 42A-D that should be closed.

Similarly, the control logic can include an open operation that requests the creation of a new application form 42A-D (FIG. 2). In this case, form system 38 can create the new application form 42A-D and form tree system 36 can add the new application form 42A-D to form tree 50A (FIG. 2) as a child of the source application form 42A-D or as a root form of form tree 50A. Additionally, processing system 39 can provide the corresponding rendering information for processing by application 40.

When communicating over network 18, a communications link between server 12 and client 14 may be lost. To this extent, application 40 may continue to maintain a session with management system 30, while management system 30 has closed the session. As a result, when application 40 sends a request using the old session, session system 34 will create a new active session for application 40. In this case, management system 30 can re-generate form tree 50 for application 40. For example, interface system 32 may receive a request comprising an invalid session identifier from application 40. In response, form tree system 36 can create a new form tree for the active session, and interface system 32 can provide a response that includes the identifier for the active session and a request to reconnect for processing by application 40.

Upon receiving the request to reconnect and new session identifier, application 40 can send one or more requests to management system 30 that include information for each application form 42 currently associated with application 40. Interface system 32 can receive the request and form system 38 can create application form 42 based on the request. In particular, the specified application form 42 can be located, a default application form 42 can be created, and the application form 42 can be initialized with one or more properties included in the request. Additionally, form tree system 36 can add application form 42 to form tree 50 based on the request. In particular, when no parent application form 42 is specified in the request, application form 42 can be added as the root node in form tree 50. Alternatively, application form 42 can be added as a child of the specified application form 42. In any event, application 40 can continue to send requests to re-generate form tree 50 until it is complete.

Further details of the invention are now described using an illustrative embodiment in which application form 42 is generated based on a JSF form. As is known, JSF processing includes four phases; a reconstitute component tree phase, an apply request values phase, an invoke application phase, and a render response phase. The following discussion is limited to modifications made to the request/response syntax and each of these processing phases according to one embodiment of the invention.

Initially, several modifications to the JSF request syntax are necessary to enable support for multiple application forms 42. In particular, application 40 may generate four different types of requests that are provided to management system 30 for processing; a request for a first JSF form (application form 42), a request for an existing JSF form, a request that includes a user interface event that occurred on an existing JSF form, and a request that includes a user interface event that occurred for a component on an existing JSF form. For the first JSF form, the request can comprise a uniform resource locator (URL) address having a prior art format of:
“mycompany.com/formName.jsp”

However, each of the other types of requests will include identification information for one or more of the JSF forms. As a result, a request for an existing JSF form can include both the session identifier and the identifier of the JSF form. For example, the format may comprise:
“mycompany.com/formName.jsp?
   session=sessionID&
   form=formName.formInstanceName”

Similarly, a request that includes a user interface event that occurred for a JSF form can include the session identifier, an identifier of the current JSF form, and an indication of the user interface event that includes the JSF form that generated the event. For example, the format may comprise:
“mycompany.com/formName.jsp?
   session=sessionID&
   form=formName.formInstanceName&
   formName.formInstanceName.close=true”

Further, a request that includes a user interface event that occurred for a component can include the session identifier, an identifier of the current JSF form, and an indication of the user interface event that includes the JSF form and component that generated the event. For example, the format may comprise:
“mycompany.com/formName.jsp?
   session=sessionID&
   form=formName.formInstanceName&
   formName.formInstanceName.componentName.eventName=true”

In the latter three types of requests, a set (one or more) of component property values may be included. In this case, each component property value can include a form name, form instance name, component name, property name, and property value. For example, the format for each component property value may comprise:
“formName.formInstanceName.componentName.propertyName=propertyValue”

In order to reduce the text string required to transmit the request, one or more identifiers can be used to represent a combination of name specifiers. For example, an identifier “formID” could be used to replace each instance of “formName.formInstanceName” where it occurs in any of the requests described above. Similarly, an identifier “componentID” could be used to replace “formName.formInstanceName.componentName” where it would otherwise appear in a request. It is understood that each identifier can be defined in any manner and comprise any combination of characters and/or numbers as is known in the art.

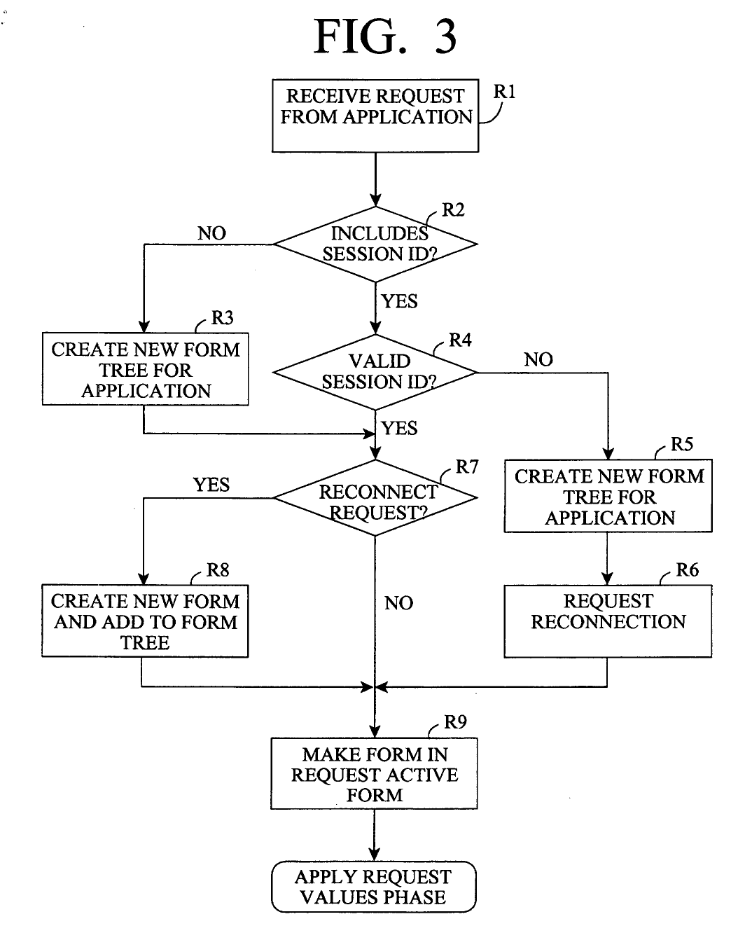

In any event, once a request is received, management system 30 processes the request. As stated above, initially, management system 30 can perform a reconstitute component tree phase of processing. FIG. 3 shows illustrative steps for performing the reconstitute component tree phase, which are discussed in conjunction with system 10 shown in FIG. 1. In step R1, interface system 32 receives the request from application 40. In step R2, interface system 32 determines whether the request includes a session identifier. When no session identifier is included, the request is for the first JSF form, and in step R3, form tree system 36 generates form tree 50 for application 40. Otherwise, in step R4, session system 34 determines if the session identifier is valid. If the session identifier is not valid, then in step R5, form tree system 36 creates form tree 50 for application 40, and in step R6, form system 38 generates a request for application 40 to reconnect with management system 30 using the active session in order to re-generate the JSF form(s).

While reconnecting, application 40 will send one or more reconnect requests that enable form system 38 to re-generate the JSF form(s) and form tree system 36 to re-generate the corresponding form tree 50 for application 40. To this extent, when a valid session identifier is included in the request, in step R7, interface system 32 can determine if the request comprises a reconnect request. If it does, then in step R8, form system 38 can create the JSF form, and form tree system 36 can add the new JSF form to form tree 50 based on the reconnect request. In any event, in step R9, the JSF form in the request is made the active JSF form in form tree 50 before processing continues to the apply request values phase.

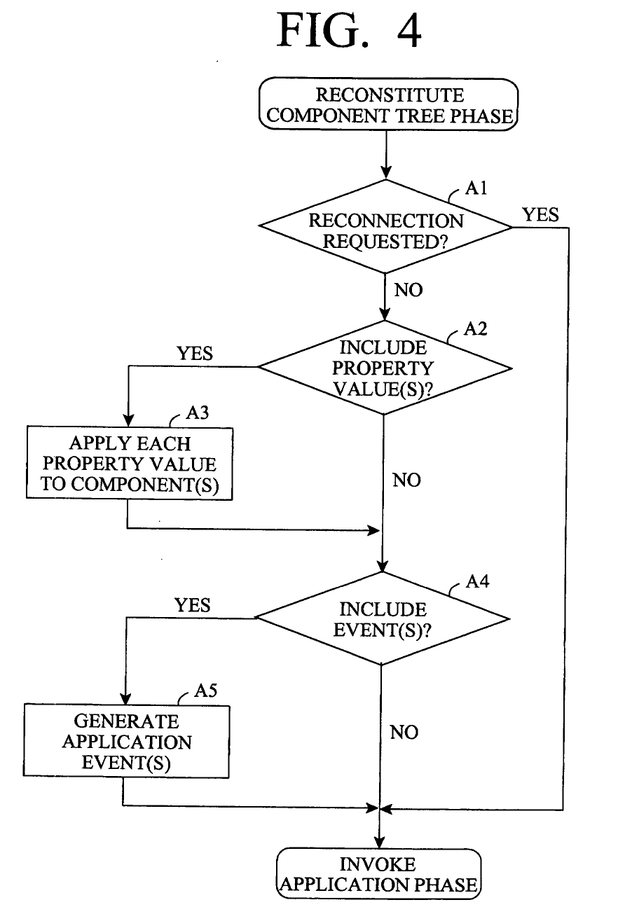

FIG. 4 shows illustrative steps for performing the apply request values phase, which are discussed in conjunction with system 10 shown in FIG. 1. In step A1, processing system 39 determines if reconnection has been requested. If it has, then processing proceeds to the invoke application phase. Otherwise, in step A2, processing system 39 determines if the request includes one or more property values. If it does, then in step A3, processing system 39 applies each property value to form tree 50. Regardless, in step A4, processing system 39 determines if the request includes one or more user interface events. If it does, then in step A5, processing system 39 generates one or more application events based on the user interface events. In any case, processing proceeds to the invoke application phase.

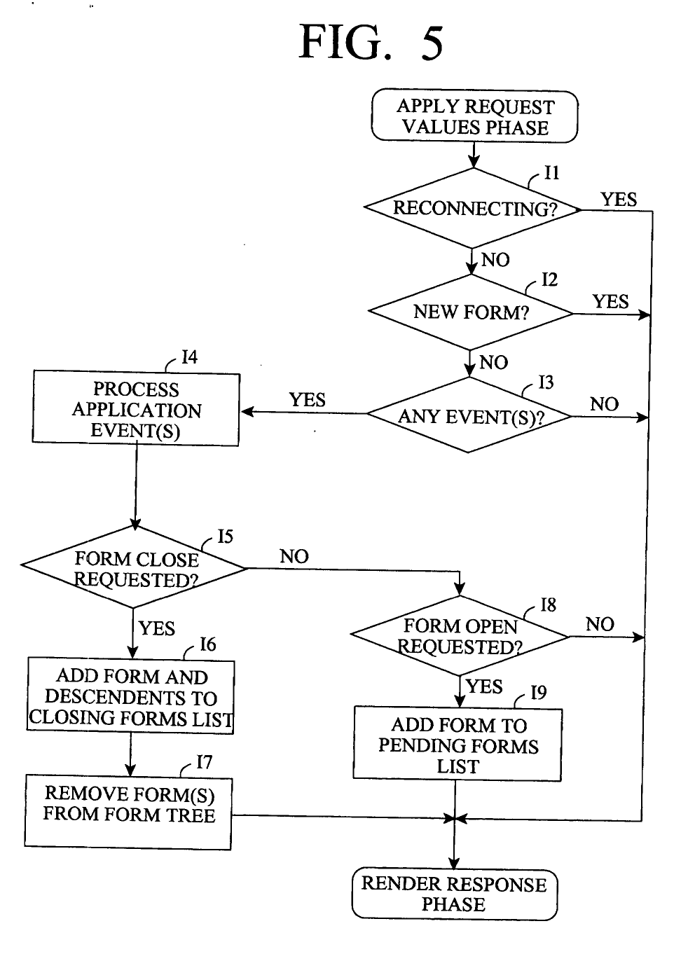

In one embodiment, processing system 39 comprises a multi-form application handler to implement the invoke application phase. In this case, the multi-form application handler processes the application event(s) that were generated during the apply request values phase. Regardless, FIG. 5 shows illustrative steps for performing the invoke application phase, which are discussed in conjunction with system 10 shown in FIG. 1. In step 11, processing system 39 determines if the request comprises reconnection information or if reconnection has been requested. In either case, processing proceeds to the render response phase. Otherwise, in step 12, processing system 39 determines if the request is for a new JSF form. If not, then in step 13, processing system 39 determines if any application events are present that require processing. When the request is for a new JSF form or there are no application events, processing proceeds to the render response phase.

Otherwise, in step 14, processing system 39 processes the application event(s). In step 15, processing system 39 determines if a JSF form is being closed as a result of the application event. If so, then in step 16, form tree system 36 adds the specified JSF form and each of its descendent JSF form(s), if any, to a closing forms list, and in step 17, form tree system 36 removes each JSF form(s) from form tree 50. Otherwise, in step 18, processing system 39 determines if a JSF form is being opened as a result of the application event. If so, then in step 19, form tree system 36 adds the new JSF form to a pending forms list. In any event, processing proceeds to the render response phase.

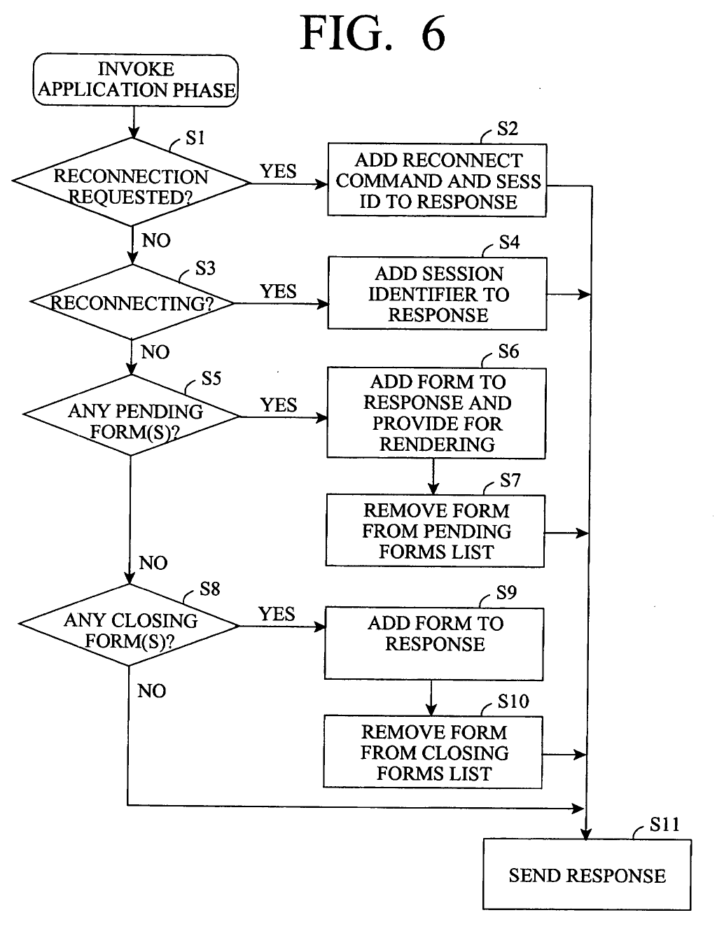

In one embodiment, interface system 32 can comprise a multi-form view handler for processing the render response phase. Regardless, FIG. 6 shows illustrative steps for performing the render response phase, which are discussed in conjunction with system 10 shown in FIG. 1. In step S1, interface system 32 determines if reconnection was requested. If so, then in step S2, a reconnect command and session identifier are added to a response to request that application 40 provide each JSF form and its corresponding property values to management system 30. Otherwise, in step S3, interface system 32 determines if a reconnection is occurring. If so, then in step S4, the session identifier for the active session is added to the response. Otherwise, in step S5, interface system 32 determines if the pending forms list has any pending JSF forms. If so, then in step S6, interface system 32 adds the JSF form(s) to the response and provides each pending JSF form to form system 38 (e.g., a Java Server Page (JSP) processor) for rendering. In step S7, interface system 32 removes the JSF form from the pending forms list. Similarly, in step S8, interface system 32 determines if the closing forms list includes any closing JSF forms. If so, then in step S9, interface system 32 adds the JSF form(s) to the response, and in step S10, interface system 32 removes each JSF form from the closing forms list. Finally, in step S11, the response is sent for processing by application 40.

When one or more JSF forms require rendering, form system 38 can render one JSF form, and if necessary, include an identifier of one or more additional JSF forms to indicate to application 40 that it should request the additional JSF form(s). Subsequently, application 40 will generate any necessary request(s), and the updated JSF form(s) will be provided to application 40 for display to user 16. Similarly, when the request includes identifier(s) for one or more JSF forms that are to be closed, application 40 can close the corresponding windows displayed to user 16.

It should be appreciated that the teachings of the present invention could be offered as a business method on a subscription or fee basis. For example, management system 30 (FIG. 1) could be created, maintained, supported and/or deployed by a service provider that offers the functions described herein for customers. That is, a service provider could offer to manage application forms (e.g., Java Server Faces Forms) as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of managing application forms on a server, the method comprising:
generating a form tree for an application executing on a client;
generating a first application form for the application; and
adding the first application form to the form tree.

2. The method of claim 1, further comprising:
receiving a user interface event from the application; and
applying the user interface event to the form tree.

3. The method of claim 2, wherein the applying step includes applying a property value for the user interface event to the form tree.

4. The method of claim 2, wherein the applying step includes processing control logic for the user interface event.

5. The method of claim 4, wherein the processing step includes:
closing the first application form; and
removing the first application form from the form tree.

6. The method of claim 4, wherein the processing step includes:
creating a second application form for the application; and
adding the second application form to the form tree as a child of the first application form.

7. The method of claim 2, further comprising providing rendering information for processing by the application.

8. The method of claim 1, wherein the generating a form tree step includes:
receiving a request for the first application form; and
creating the form tree for an active session.

9. The method of claim 1, wherein the generating a form tree step includes:
receiving a request comprising an invalid session from the application;
creating the form tree for an active session; and
providing an identifier for the active session and a request to reconnect for processing by the application.

10. The method of claim 1, wherein the generating a first application form step includes:
receiving a request that includes information for the first application form;
creating the first application form; and
initializing the first application form based on the request.

11. A method of managing Java Server Faces (JSF) forms on a server, the method comprising:
generating a form tree for an application executing on a client;
generating a first JSF form for the application; and
adding the first JSF form as a root form for the form tree.

12. The method of claim 11, wherein the generating a form tree step includes:
receiving a request for the first JSF form from the application; and
creating the form tree for the session.

13. The method of claim 11, further comprising providing the first JSF form for rendering by the application.

14. The method of claim 13, wherein the providing step includes adding the first JSF form to a pending forms list.

15. The method of claim 11, further comprising:
receiving a user interface event from the application; and
applying the user interface event to the form tree.

16. The method of claim 15, wherein the applying step includes processing control logic for the user interface event.

17. The method of claim 16, wherein the processing step includes:
creating a second JSF form for the application; and
adding the second JSF form to the form tree as a child of the first JSF form.

18. The method of claim 16, wherein the processing step includes:
obtaining a source JSF form that corresponds to the user interface event from the form tree;
closing the source JSF form;
removing the source JSF form from the form tree; and
adding the source JSF form to a closing forms list.

19. The method of claim 15, wherein the applying step includes:
obtaining a source JSF form that corresponds to the user interface event from the form tree;
obtaining a component tree for the source JSF form; and
applying the user interface event to the component tree.

20. A system for managing application forms on a server, the system comprising:
a form system for generating an application form for an application executing on a client; and
a form tree system for generating a form tree for the application and adding the application form to the form tree.

21. The system of claim 20, further comprising a session system for managing a session for communications between the application and the server.

22. The system of claim 20, further comprising an interface system for receiving a user interface event from the application.

23. The system of claim 22, further comprising a processing system for applying the user interface event to the form tree.

24. The system of claim 22, wherein the interface system further provides rendering information for processing by the application.

25. A program product stored on a recordable medium for managing application forms on a server, which when executed comprises:
program code for generating a form tree for an application executing on a client;
program code for generating a first application form for the session; and
program code for adding the first application form to the form tree.

26. The program product of claim 25, further comprising:
program code for receiving a user interface event from the application; and
program code for applying the user interface event to the form tree.

27. The program product of claim 26, further comprising program code for providing rendering information for processing by the application.

28. The program product of claim 25, further comprising program code for managing a communication session between the application and the server.

29. A method of deploying an application for managing application forms on a server, the method comprising:
providing a computer infrastructure being operable to:
generate a form tree for an application executing on a client;
generate an application form for the application;
add the application form to the form tree;
receive a user interface event from the application; and
apply the user interface event to the form tree.

30. Computer software embodied in a propagated signal for managing application forms on a server, the computer software comprising instructions to cause a computer system to perform the following functions:
generate a form tree for an application executing on a client;
generate an application form for the application;
add the application form to the form tree;
receive a user interface event from the application; and
apply the user interface event to the form tree.
